(19) United States
(12) Patent Application Publication
(10) Pub. No.: US 2025/0293716 A1
(43) Pub. Date: Sep. 18, 2025

(54) TRANSMIT SPUR MITIGATION

(71) Applicant: QUALCOMM Incorporated, San Diego, CA (US)

(72) Inventors: Ke GONG, Irvine, CA (US); Jian LIU, Shanghai (CN); Qiang HUANG, Shanghai (CN); Rabih MAKAREM, Irvine, CA (US)

(21) Appl. No.: 18/854,633

(22) PCT Filed: Jun. 3, 2022
(86) PCT No.: PCT/CN2022/097023

§ 371 Date: Oct. 7, 2024

(51) Int. Cl. H04B 1/04; H04B 17/11

(52) U.S. Cl. CPC H04B 1/04; H04B 17/11

(57) ABSTRACT

Aspects of the present disclosure provide techniques and apparatus for transmit spur mitigation. An example method of signal transmission by a transceiver generally includes outputting a first signal from a transmit chain in a first state, determining that a power associated with the first signal violates a spectral mask, and outputting a second signal from the transmit chain in a second state in response to the determination, the second state being different from the first state.

### BACKGROUND

### Field of the Disclosure

Certain aspects of the present disclosure generally relate to electronic circuits and, more particularly, to a radio frequency transceiver.

### Description of Related Art

Electronic devices include traditional computing devices such as desktop computers, notebook computers, tablet computers, smartphones, wearable devices like a smartwatch, internet servers, and so forth. These various electronic devices provide information, entertainment, social interaction, security, safety, productivity, transportation, manufacturing, and other services to human users. These various electronic devices depend on wireless communications for many of their functions. Wireless communication systems and devices are widely deployed to provide various types of communication content such as voice, video, packet data, messaging, broadcast, and so on. Wireless communication devices may transmit and/or receive radio frequency (RF) signals via any of various suitable radio access technologies (RATs) including, but not limited to, 5G New Radio (NR), Long Term Evolution (LTE), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., IEEE 802.11), and the like.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages that include reduced adjacent channel interference, improved error vector magnitude performance, and allowance for online detection of a spectral mask violation.

Certain aspects of the present disclosure provide a method of signal transmission. The method generally includes outputting a first signal from a transmit chain in a first state, determining that a power associated with the first signal violates a spectral mask, and outputting a second signal from the transmit chain in a second state in response to the determination, the second state being different from the first state.

Certain aspects of the present disclosure provide an apparatus for signal transmission. The apparatus generally includes a memory and a processor coupled to the memory. The processor is configured to cause a transceiver to output a first signal from a transmit chain in a first state. The processor is further configured to determine that a power associated with the first signal violates a spectral mask. The processor is also configured to cause the transceiver to output a second signal from the transmit chain in a second state in response to the determination, the second state being different from the first state.

Certain aspects of the present disclosure provide an apparatus for signal transmission. The apparatus generally includes means for outputting a first signal from a transmit chain in a first state; means for determining that a power associated with the first signal violates a spectral mask; and means for outputting a second signal from the transmit chain in a second state in response to the determination, the second state being different from the first state.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example radio frequency transceiver.

FIG. 2 is a block diagram illustrating further details of an example radio frequency transceiver configured to perform transmit spur mitigation.

FIG. 3 is a flow diagram illustrating example operations for transmit spur mitigation.

FIG. 4 is a graph illustrating an example of a spectral power response of a transceiver with respect to a spectral mask.

FIG. 5 is a flow diagram of example operations for transmit spur mitigation.

FIG. 6 is a diagram of a wireless communication network that includes a wireless communication device configured to perform transmit spur mitigation.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure relate to circuitry for transmit spur mitigation and a method of performing transmit spur mitigation.

In certain wireless communication systems (e.g., IEEE 802.11 wireless systems), spectral masks are used to ensure that a transmission does not emit too much radiation in adjacent channels or subbands. A spectral mask may define maximum transmit powers allowed at certain frequencies across a channel bandwidth and adjacent frequency bands. In certain cases, the spectral mask may be in terms of power levels relative (e.g., dBr) to a peak transmit power across a certain frequency band. A spectral mask may serve to reduce adjacent-channel interference by limiting excessive radiation at frequencies adjacent to a bandwidth of a transmission. In certain aspects, the spectral mask may depend on a bandwidth of the channel and/or a generation of radio access technology (RAT). The generation of the RAT may refer to a specific generation of IEEE 802.11, such as IEEE 802.11a, 802.11n, 802.11ac, 802.11be, etc. For example, a different spectral mask may be used for a 20 MHz channel compared to a 40 MHz channel, and different spectral masks may be used for IEEE 802.11n compared to the spectral masks used for IEEE 802.11ac.

For example, for a channel with a 20 MHz bandwidth, the spectral mask may provide that at ±9 MHz from the center frequency of the bandwidth, the maximum transmit power may be at most zero decibels relative to the peak transmit power (dBr). The spectral mask may also provide that at ±11 MHz from the center frequency of the bandwidth, the maximum transmit power may be at most −20 dBr. The spectral mask may provide that at ±20 MHz from the center frequency of the bandwidth, the maximum transmit power may be at most −28 dBr. The spectral mask may provide that at ±30 MHz from the center frequency of the bandwidth, the maximum transmit power may be at most −40 dBr.

A wireless communication device may include a transceiver (also referred to as a radio frequency front-end (RFFE) circuit or RF transceiver circuit) for transmitting and/or receiving RF signals. In certain cases, the transceiver may produce spurious RF emissions at certain frequencies, such as frequencies adjacent to a bandwidth. A spurious emission may be referred to as a “spur,” where, in general, a spur may represent an unwanted signal, for example, due to harmonics, intermodulation, leakage, or interference. A spur may result in too much adjacent channel leakage and/or adjacent channel interference. For example, in a transceiver, spurs may cause a violation of a spectral mask at certain channels. That is, the spur may exceed the allowable transmit power levels provided by a spectral mask. In certain cases, the spur may be caused due to harmonics being produced by certain circuitry, such as a baseband phase-locked loop (BB-PLL) and/or a local oscillator (LO), for example. The spur may cause a marginal spectral mask failure over time.

As an example, to reduce the power level of a spur, the transceiver may use a higher transmit baseband filter (BBF) gain and a reduced RF gain, if the spur level is relatively insensitive to the BBF gain. In certain cases, a gain look-up table change can alleviate a spectral mask violation, where the gain look-up table may provide gains for different components in the transceiver for certain channels and transmit power levels. The gain look-up table change may result in a degraded error vector magnitude (EVM) performance especially for a high modulation and coding scheme (MCS) rate due to degraded linearity. The gain look-up table change may be implemented for certain channels that exhibit spurious emissions. In certain cases, the spurious channels may suffer from EVM degradation no matter if the spur level fails the spectral mask or not.

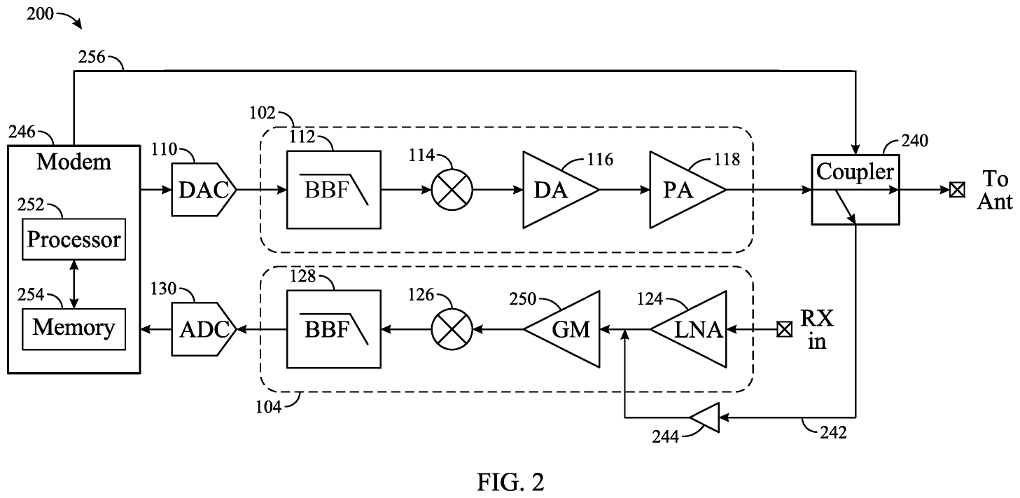

Certain aspects of the present disclosure provide methods and apparatus for transmit spur mitigation. In order to improve the EVM performance at spurious channels, the transceiver may dynamically adjust the gain(s) across certain circuitry (e.g., BBF gain, power amplifier gain, etc.) by monitoring for a spectral mask violation. For example, the transceiver may measure, correlate, and calculate the spur level using a feedback path coupling the transmit chain of the transceiver to the receive chain, as further described herein, with respect to FIG. 2. The transceiver may determine if the spectral mask is violated based on the transmit signal sampled using the feedback path between the transmit chain and receive chain. In response to detecting a spectral mask violation, the transceiver may transmit a signal using gain(s) from a specific look-up table configured for spurious emission mitigation.

The methods and apparatus for transmit spur mitigation described herein may provide various advantages. For example, the methods and apparatus for transmit spur mitigation described herein may allow for online spur detection, where the transceiver can respond to spurious emissions forming due to changes in operating conditions, such as transmit power change, MCS change, temperature change, etc. The methods and apparatus for transmit spur mitigation described herein may alleviate the EVM degradation with the specific look-up table configured for spurious emission mitigation. The methods and apparatus for transmit spur mitigation described herein may maximize the transmit EVM performance across voltage and temperature and avoid EVM degradation.

### Example RF Transceiver

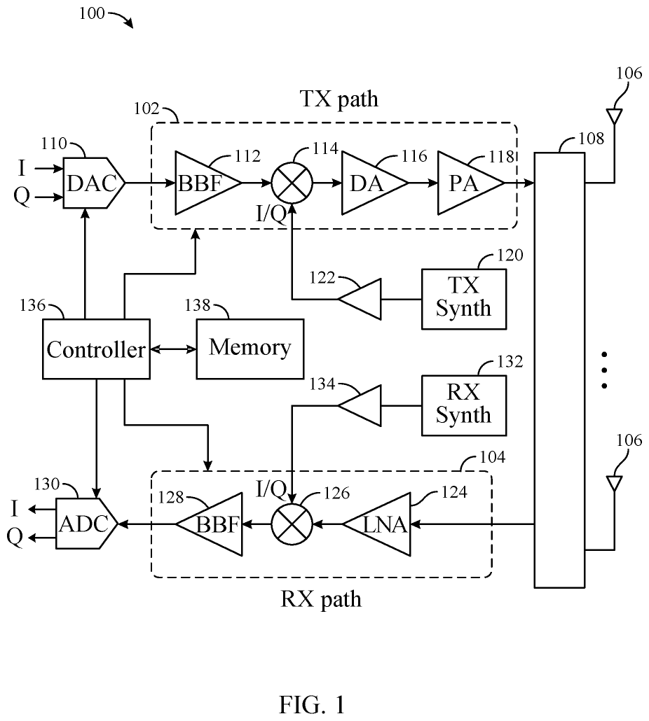

FIG. 1 is a block diagram of an example RF transceiver circuit 100, in accordance with certain aspects of the present disclosure. The RF transceiver circuit 100 includes at least one transmit (TX) path 102 (also known as a “transmit chain”) for transmitting signals via one or more antennas 106 and at least one receive (RX) path 104 (also known as a “receive chain”) for receiving signals via the antennas 106. When the TX path 102 and the RX path 104 share an antenna 106, the paths may be connected with the antenna via an interface 108, which may include any of various suitable RF devices, such as a switch, a duplexer, a diplexer, a multiplexer, and the like.

Receiving in-phase (I) or quadrature (Q) baseband analog signals from a digital-to-analog converter (DAC) 110, the TX path 102 may include a baseband filter (BBF) 112, a mixer 114, a driver amplifier (DA) 116, and a power amplifier (PA) 118. The BBF 112, the mixer 114, the DA 116, and the PA 118 may be included in a radio frequency integrated circuit (RFIC), for certain aspects. For other aspects, the PA 118 (and/or other components) may be external to the RFIC.

The BBF 112 filters the baseband signals received from the DAC 110, and the mixer 114 mixes the filtered baseband signals with a transmit local oscillator (LO) signal to convert the baseband signal of interest to a different frequency (e.g., upconvert from baseband to a radio frequency). This frequency conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 114 are typically RF signals, which may be amplified by the DA 116 and/or by the PA 118 before transmission by the antenna 106.

The RX path 104 may include a low noise amplifier (LNA) 124, a mixer 126, and a baseband filter (BBF) 128. The LNA 124, the mixer 126, and the BBF 128 may be included in a RFIC, which may or may not be the same RFIC that includes the TX path components. RF signals received via the antenna 106 may be amplified by the LNA 124, and the mixer 126 mixes the amplified RF signals with a receive local oscillator (LO) signal to convert the RF signal of interest to a different baseband frequency (e.g., downconvert). The baseband signals output by the mixer 126 may be filtered by the BBF 128 before being converted by an analog-to-digital converter (ADC) 130 to digital I or Q signals for digital signal processing.

Certain transceivers may employ frequency synthesizers with a variable-frequency oscillator (e.g., a voltage-controlled oscillator (VCO) or a digitally controlled oscillator (DCO)) to generate a stable, tunable LO with a particular tuning range. Thus, the transmit LO may be produced by a TX frequency synthesizer 120, which may be buffered or amplified by amplifier 122 before being mixed with the baseband signals in the mixer 114. Similarly, the receive LO may be produced by an RX frequency synthesizer 132, which may be buffered or amplified by amplifier 134 before being mixed with the RF signals in the mixer 126. For certain aspects, a single frequency synthesizer may be used for both the TX path 102 and the RX path 104.

A controller 136 may direct the operation of the RF transceiver circuit 100, such as transmitting signals via the TX path 102 and/or receiving signals via the RX path 104. In certain aspects, the controller 136 may perform operations further described herein related to transmit spur mitigation. The controller 136 may include a processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 138 may store data and program codes for operating the RF transceiver circuit 100. The controller 136 and/or memory 138 may include control logic (e.g., CMOS logic).

While FIG. 1 provides an RF transceiver as an example application in which certain aspects of the present disclosure may be implemented to facilitate understanding, certain aspects described herein related to transmit spur mitigation may be utilized in various other suitable electronic systems.

### Example Transmit Spur Mitigation

FIG. 2 is a block diagram illustrating example RF transceiver 200 configured to perform transmit spur mitigation. The RF transceiver 200 may include the circuitry of the RF transceiver circuit 100. The RF transceiver 200 may also include a coupler 240, a feedback path 242, a feedback component 244, and a modem 246. In certain cases, the RF transceiver 200 may include a transconductance amplifier 250. FIG. 2 is just one example of an RF transceiver, and other circuitry including fewer, additional, or alternative elements or components are possible and consistent with this disclosure.

The coupler 240 may include an RF coupler or RF switch. The coupler 240 may selectively couple an output of the transmit chain 102 to the receive chain 104. For example, the coupler 240 may be coupled to the output of the PA 118 and to the output of the LNA 124 (and/or to the input of the transconductance amplifier 250). The coupler 240 may be coupled to the receive chain 104 via a feedback path 242. The feedback path 242 may allow for the transmit signal output from the transmit chain 102 to be fed back to the receive chain 104. In the case of an RF switch, the coupler 240 may be coupled to the modem 246 via a control path 256, which may carry a signal to indicate whether to open or close the connection of the coupler 240 to the feedback path 242. In certain cases, the feedback path 242 may be used for evaluating transmit power compliance with the spectral mask, as well as other operations, such as digital predistortion (DPD) characterization and/or transmit power control measurements.

The feedback component 244 may include an amplifier, a buffer, an attenuator, or a combination thereof. In some cases, the feedback component may include a voltage buffer and/or a current buffer. The feedback component 244 may be coupled between the coupler 240 and the receive chain 104, for example, along the feedback path 242. The feedback component 244 may electrically isolate the receive chain 104 from the transmit chain 102. The feedback component 244 may prevent the transmit chain 102 from overloading the receive chain 104.

The modem 246 may be coupled to the input of the DAC 110 and the output of the ADC 130. The modem 246 may perform digital modulation and/or demodulation on a data stream. The modem 246 may perform various digital processing on the data stream, such as scrambling, modulation (e.g., quadrature phase-shift keying (QPSK) or quadrature amplitude modulation (QAM)), layer mapping, and/or spatial processing (e.g., precoding). In some cases, the modem 246 may encode/decode the data stream across multiple carrier frequencies, for example, via orthogonal frequency-division multiplexing (OFDM).

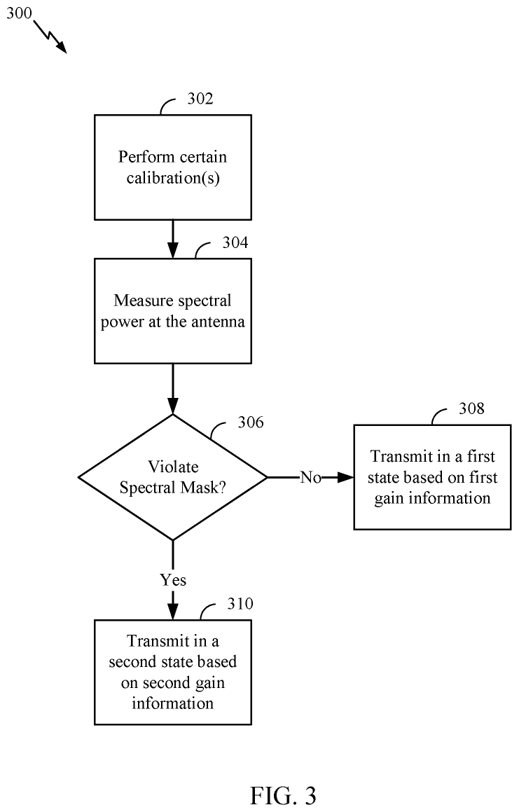

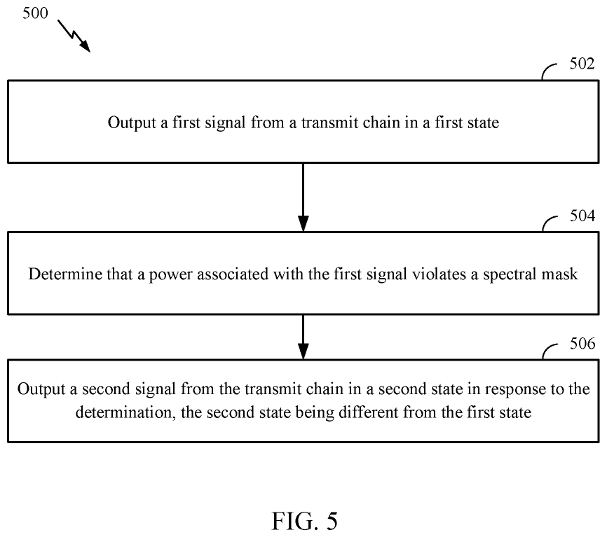

The modem 246 may include a processor 252 and memory 254, where the processor 252 is communicably coupled to the memory 254. The processor 252 may include the controller 136, a DSP, an ASIC, a FPGA or other PLD, discrete gate or transistor logic, discrete hardware components, or any combination thereof. The memory 254 may be a non-transitory computer-readable medium. The memory 254 may store instructions (e.g., computer-executable code) that when executed by the processor 252, cause the processor 252 to perform the operations for transmit spur mitigation described herein, for example, with respect to FIG. 3 and/or FIG. 5.

As an example, the processor 252 may obtain a signal output from the transmit chain 102 via the coupler 240 selectively coupling the transmit chain 102 to the receive chain 104 through the feedback path 242. The processor 252 may compare the spectral power of the signal to a spectral mask and determine whether the power of the signal violates the spectral mask. If the power of the signal violates the spectral mask, the processor 252 may determine to implement a change in the gain(s) used across the transmit chain 102. The processor 252 may dynamically adjust the gains used across the transmit chain 102 in response to detecting a spectral mask violation. For example, the processor 252 may adjust the specific gain(s) used for the BBF 112, DA 116, the mixer 114, and/or PA 118. In certain aspects, the processor 252 may use gains specified in a look-up table configured for transmit spur mitigation, where each of the gains is associated with a specific element (e.g., the BBF 112, DA 116, the mixer 114, and/or PA 118) in the transmit chain 102.

The transconductance (GM) amplifier 250 may allow the receive chain 104 to operate in a current mode rather than a voltage mode. In certain aspects, the GM amplifier 250 may include a low noise transconductance amplifier (LNTA). The GM amplifier 250 may output a current in response to a differential input voltage (not shown). The GM amplifier 250 may allow the use of a passive mixer as the mixer 126 to improve the linearity and noise performance of the receive chain 104. The GM amplifier 250 may convert the RF signal to a current and drive the mixer 126 with the current mode.

FIG. 3 illustrates a flow diagram of example operations 300 for transmit spur mitigation. The operations 300 may be performed by a transceiver, such as the RF transceiver 200, for example. In certain aspects, the operations may be performed (or at least caused to be performed) by a processor of the transceiver, such as the processor 252.

The operations 300 may optionally begin at block 302, where the transceiver may perform certain calibration(s). For example, the transceiver may calibrate the predistortion used for the PA, such as the PA 118, to reduce the non-linearity of the PA. The transceiver may calibrate harmonic or intermodulation cancellation implemented to suppress harmonics generated by certain circuitry, such as a mixer and/or PA. The transceiver may calibrate cancellation for self-interference to improve the isolation between the transmit chain and the receive chain. The calibrations may be performed at the factory before the wireless communication device is deployed.

At block 304, the transceiver may measure the spectral power output from the transmit chain, for example, at the antenna. The transceiver may output a signal (e.g., a modulated signal) from the transmit chain in a first state, where the first state may correspond to operating the transmit chain with first gain information (e.g., a gain look-up table) associated with circuitry (e.g., BBF, mixer, DA, and/or PA) in the transmit chain. The first gain information may provide default sets of gains to use for different circuitry across the transmit chain at different power levels, and the first gain information may be used specifically when there is no spectral mask violation (i.e., when the spectral power of the transmission satisfies the spectral mask). The transceiver may obtain the signal output from the transmit chain via a feedback path, such as the feedback path 242 coupling the transmit chain 102 to the receive chain 104 as depicted in FIG. 2. The transceiver may control a coupler (e.g., the coupler 240) to couple the transmit chain 102 to the receive chain 104. In certain aspects, the transceiver may adjust the gains applied to the transmit chain and/or receive chain to allow for the modem of the transceiver to decode the spectral power of the output signal. The transceiver may record or capture samples of the output signal to measure the spectral power of the signal. The transceiver may convert the spectral power of the signal to a relative power level, such as by using the peak transmit power of the signal as a reference power level.

At block 306, the transceiver may determine whether the power of the signal (e.g., the spectral power) violates a spectral mask, for example, depending on the channel bandwidth and/or generation of RAT (e.g., IEEE 802.11a, 802.11n, 802.11ac, 802.11be, etc.) used for the transmission. The transceiver may compare the spectral power of the signal to the spectral mask. The transceiver may select the spectral mask for comparison from a table of spectral mask power levels. The table may include sets of maximum power levels associated with the channel bandwidth and peak transmit power level, where each of the sets of maximum power levels may include power levels at different frequencies relative to the center frequency of the bandwidth, for example, ±9 MHz from the center frequency, ±11 MHz, ±20 MHz, and ±30 MHz. The transceiver may be preconfigured with the table of spectral mask powers, and the table may be generated based on certain spectral masks, for example, IEEE spectral mask standards.

If the spectral power of the signal satisfies the spectral mask, at block 308, the transceiver may continue to transmit in the first state. For example, the transceiver may continue to transmit the signal based on the first gain information in response to detecting that the power of the signal satisfies the spectral mask.

If the spectral power of the signal violates the spectral mask, at block 310, the transceiver may transmit in a second state, where the second state corresponds to operating the transmit chain with second gain information different from the first gain information. The second gain information may provide alternative sets of gains to use for the circuitry in the transmit chain at different power levels. The second gain information may be used specifically when the spectral mask is violated. The second gain information may be configured to allow the transmission to satisfy the spectral mask when a spectral mask violation is detected. The transceiver may adjust the gains applied to certain circuitry in the transmit chain. For example, the transceiver may increase the gain applied to the BBF and decrease the gain applied to the PA relative to the first information. The transceiver may adjust the gain applied to the circuitry in the transmit chain based on the second gain information.

In certain aspects, the transceiver may evaluate the spectral mask compliance of the transmit chain for various operating conditions, such as different transmit power levels, different gain levels or indices, different channel bandwidths, different frequencies, different operating temperatures, different supply voltages, etc. For example, the transceiver may re-perform the operations 300 starting at block 304. For each of the operating conditions (or combinations of operating conditions), the transceiver may repeat measuring the spectral power of the transmit chain at block 304 and determining if there is a spectral mask violation for the respective operating condition (or combination of operating conditions) at block 306. The transceiver may store the results and apply the first gain information or the second gain information depending on the current operating conditions of the transceiver. For example, suppose it is detected that the transceiver will be operating in violation of the spectral mask based on the previous spectral power measurements (e.g., a specific temperature and transmit frequency combination may produce a spectral mask violation), the transceiver may switch to using the second gain information to operate the transmit chain in response to such a detection.

For certain aspects, the transceiver may evaluate the spectral mask compliance of the transmit chain periodically and/or in response to certain event(s), such as a change in operating conditions. For example, the transceiver may evaluate the spectral mask compliance of the transmit chain periodically every 500 milliseconds, one second, or ten seconds. In some cases, the transceiver may evaluate the spectral mask compliance of the transmit chain in response to certain event(s), such as a change in operating temperature of the transceiver, a change in transmit power, a change in channel bandwidth, a change in frequency, or any combination thereof. Online monitoring of the spectral mask compliance of the transmit chain may allow the transceiver to dynamically respond to spectral mask violations to reduce adjacent channel leakage.

In certain cases, each of the first and second gain information may correspond to a different look-up table. The look-up tables may be used to determine the gain levels associated with circuitry in the transmit chain for certain output powers depending on whether there is a spectral mask violation. Each of the look-up tables may be associated with certain output powers of the transmit chain. For example, the look-up table may provide various gains for different output powers of the transmit chain. The look-up table may include different values of the output power (e.g., Pout_1 and Pout_2 in Table 1) associated with certain circuitry in the transmit chain. Table 1 is an example of a look-up table that may be used for setting various gains based on the output power of the transmit chain. Table 1 includes a first output power (Pout_1) associated with a first BBF gain (BBF_G1), a first DA gain (DA_G1), and a first PA gain (PA_G1), and a second output power (Pout_2) associated with a second BBF gain (BBF_G2), a second DA gain (DA_G2), and a second PA gain (PA_G2).

TABLE 1

| | | | Output Power |
|---|---|---|---|
| BBF Gain | DA Gain | PA Gain | (Pₒᵤₜ) |
| BBF_G1 | DA_G1 | PA_G1 | Pout_1 |
| BBF_G2 | DA_G2 | PA_G2 | Pout_2 |

Those of skill in the art will understand that the parameters presented in Table 1 are exemplary only. Other parameters or categories of parameters may be used in addition to or instead of those presented in Table 1 for look-up tables. For example, the gains and corresponding output power may further depend on channel bandwidth, modulation and coding scheme, transmit frequency, etc.

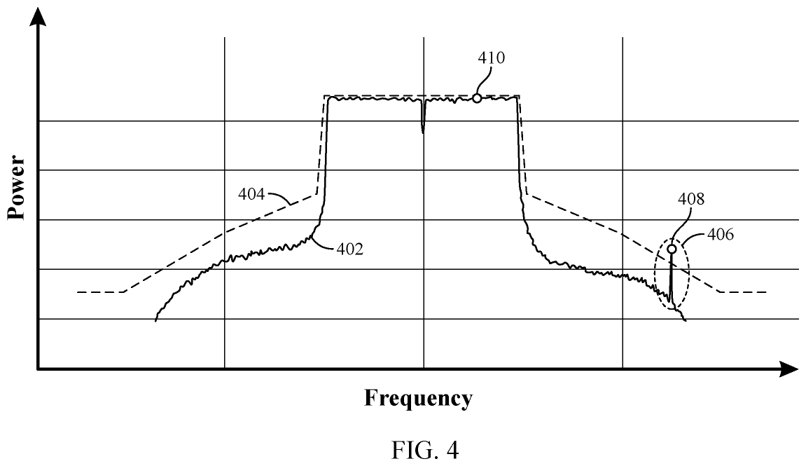

FIG. 4 is a graph illustrating an example of a spectral power response 402 with respect to a spectral mask 404 in terms of transmit power versus frequency. The spectral power response 402 may represent the power of a transmission across a certain bandwidth or spectrum output from a transmit chain (e.g., the transmit chain 102). In certain cases, the spectral power response 402 may be determined by measuring a signal output from the transmit chain, for example, via the coupler 240 and feedback path 242 as described herein with respect to FIGS. 2 and 3. In this example, the spectral power response 402 has a spur 406 at a certain frequency (e.g., a harmonic of a LO or BBF). The spur 406 has a power level 408 that exceeds the maximum power level of the spectral mask 404 at the frequency of the spur 406. That is, the spectral power response 402 violates the spectral mask 404.

In certain aspects, the power level 408 of the spur 406 may be determined relative to a peak transmit power 410 of the spectral power response 402. In certain cases, the absolute power level of the spur 406 may be used to determine if the spur 406 violates the spectral mask 404. The absolute power level may be determined based on transmit power control measurements, such as the transmit power control operations implemented for IEEE 802.11. The spectral power response 402 may be determined through digital signal processing at the modem of the transceiver, for example, by sampling the output signal with the ADC.

FIG. 5 is a flow diagram of example operations 500 for signal transmission with transmit spur mitigation. The operations 500 may be performed by a transceiver, such as the RF transceiver 200. The operations 500 may be implemented as software components (e.g., computer-executable code) that are executed and run on one or more processors (e.g., the processor 252 of FIG. 2). Further, the transmission and reception of signals by the transceiver in operations 500 may be enabled, for example, by one or more antennas (e.g., antenna 106 of FIG. 1). In certain aspects, the transmission and/or reception of signals by the transceiver may be implemented via a bus interface of a circuit (e.g., an RFIC) obtaining and/or outputting signals.

The operations 500 may optionally begin at block 502, where the transceiver may output a first signal from a transmit chain (e.g., the transmit chain 102) in a first state. For example, the transceiver may output a data signal from the transmit chain. As described herein, the first state may correspond to operating the transmit chain with first gain information (e.g., a gain look-up table) associated with circuitry (e.g., BBF, mixer, DA, and/or PA) in the transmit chain.

At block 504, the transceiver may determine that a power (e.g., the spectral power response 402) associated with the first signal violates a spectral mask (e.g., the spectral mask 404). The transceiver may obtain one or more measurements associated with the first signal while outputting the first signal from the transmit chain in the first state, and the transceiver may determine that the power associated with the first signal violates the spectral mask based at least in part on the one or more measurements associated with the first signal. The measurements associated with the first signal may include a spectral power of the first signal, such as the spectral power response 402 depicted in FIG. 4. The measurements may be in terms of a transmit power control metric or a decibel relative (dBr) to a peak spectral power of the first signal. The transceiver may compare the spectral power of the first signal to the spectral mask. In certain aspects, the transceiver may obtain the measurements associated with the first signal via a feedback path (e.g., the feedback path 242) coupling an output (e.g., the output of the PA 118) of the transmit chain to a receive chain (e.g., the receive chain 104).

At block 506, the transceiver may output a second signal from the transmit chain in a second state in response to the determination, the second state being different from the first state. The second state may correspond to operating the transmit chain with second gain information configured to satisfy the spectral mask and/or mitigate adjacent channel leakage. For example, the gains applied to circuitry in the transmit chain in the second state may be different from the gains applied to the circuitry in the first state.

The transceiver may output the second signal from the transmit chain in the second state based at least in part on information (e.g., the second gain information) associated with the second state. The information associated with the first state and the second state may include a look-up table of gains (e.g., Table 1) associated with different components in the transmit chain. The information associated with the second state may include sets of one or more gains associated with the transmit chain, and each of the sets of one or more gains may be associated with an output power of the transmit chain. The information associated with the second state may include a first set of one or more gains associated with the transmit chain and a second set of one or more gains associated with the transmit chain, where the first set of one or more gains corresponds to a first output power of the transmit chain, and the second set of one or more gains corresponds to a second output power of the transmit chain.

The transceiver may apply a particular set of gains from the information to the respective components in the transmit chain. Each of the sets of one or more gains may include a plurality of gains, and each of the plurality of gains may be associated with a different component in the transmit chain, such as the BBF, mixer, DA, and/or PA. To output the second signal, the transceiver may apply, to a respective component in the transmit chain, each of the plurality of gains in one of the sets of one or more gains corresponding to the second state.

The gain information associated with the second state may be channel specific. The gain information associated with the second state may depend on the channel used for outputting the first signal and/or the second signal. The information associated with the second state may include sets of one or more gains associated with the transmit chain, and each of the sets of one or more gains corresponds to a different frequency channel. For example, a particular set of gains may be used for a single channel.

In certain aspects, the gain information associated with the second state may be associated with multiple channels (e.g., broadband gain information). The information associated with the second state may include sets of one or more gains associated with the transmit chain across multiple frequency channels. For example, a particular set of gains may be used for multiple channels.

The spectral mask may be specified for wireless communications in a shared spectrum or a wireless local area network (WLAN). For example, the spectral mask may be provided in IEEE 802.11 standards. The spectral mask may include one or more maximum transmit powers across a frequency spectrum or bandwidth.

In certain aspects, the transceiver may iterate through different operating conditions to evaluate the spectral mask compliance. The transceiver may obtain one or more measurements associated with the first signal while outputting the first signal from the transmit chain in a plurality of states (e.g., operating conditions) or across a plurality of channels. The transceiver may determine, for each of the plurality of states or each of the plurality of channels, whether the power associated with the first signal violates the spectral mask.

For certain aspects, the transceiver may evaluate the spectral mask compliance of the transmit chain periodically and/or in response to certain event(s), as described herein. The transceiver may output a third signal from the transmit chain in the first state. The transceiver may determine that a power associated with the third signal violates the spectral mask. The transceiver may output a fourth signal from the transmit chain in the second state in response to the determination that the power associated with the third signal violates the spectral mask. The transceiver may determine that the power associated with the third signal violates the spectral mask in response to one or more criteria being satisfied. The one or more criteria may be satisfied when a timer expires and/or when an event is detected. The timer may be reset after it expires such that the transceiver evaluates the spectral compliance periodically. The transceiver may monitor one or more events that trigger evaluating the spectral mask compliance, such as a change in operating temperature of the transceiver, a change in transmit power, a change in channel bandwidth, a change in frequency, or any combination thereof.

In certain aspects, if the transceiver detects that the spectral power of a transmission satisfies the spectral mask, the transceiver may continue to operate in the first state (e.g., with the first gain information). The transceiver may output a third signal from the transmit chain in the first state. The transceiver may determine that a power associated with the third signal satisfies the spectral mask. The transceiver may output a fourth signal from the transmit chain in the first state in response to the determination of the power associated with the third signal satisfying the spectral mask.

### Example Wireless Communications Network

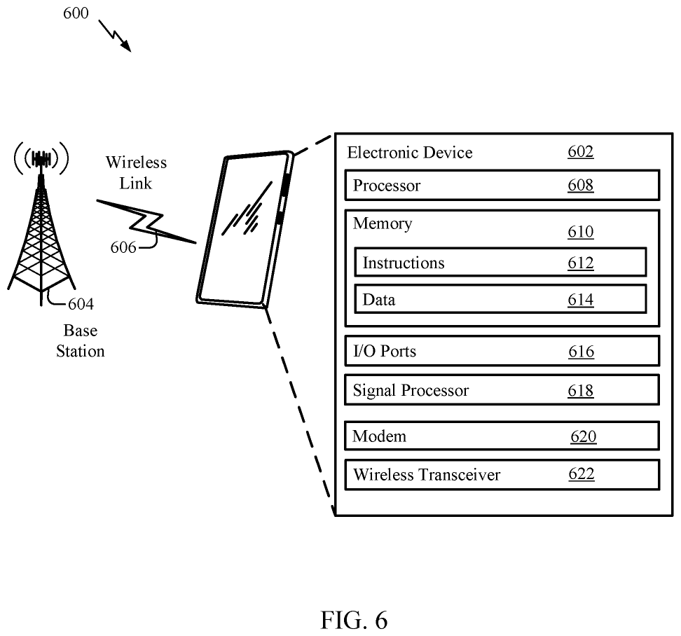

In certain aspects, the apparatus and methods for transmit spur mitigation may be used in certain wireless communication devices in a wireless network. FIG. 6 is a diagram of a wireless communication network 600 that includes a wireless communication device 602, which has a wireless transceiver 696 such as the RF transceiver circuit 100 of FIG. 1. In certain aspects, the wireless transceiver 696 may include transmit spur mitigation circuitry such as included in the RF transceiver 200.

In the wireless communication network 600, the wireless communication device 602 communicates with a base station 604 through a wireless link 606. As shown, the wireless communication device 602 is depicted as a smartphone. However, the wireless communication device 602 may be implemented as any suitable computing or other electronic device, such as a cellular base station, broadband router, access point, cellular or mobile phone, gaming device, navigation device, media device, laptop computer, desktop computer, tablet computer, server computer, network-attached storage (NAS) device, smart appliance, vehicle-based communication system, Internet of Things (IoT) device, sensor or security device, asset tracker, and so forth.

The base station 604 communicates with the wireless communication device 602 via the wireless link 606, which may be implemented as any suitable type of wireless link. Although depicted as a base station tower of a cellular radio network, the base station 604 may represent or be implemented as another device, such as a satellite, terrestrial broadcast tower, access point, peer-to-peer device, mesh network node, fiber optic line, another electronic device generally as described above, and so forth. Hence, the wireless communication device 602 may communicate with the base station 604 or another device via a wired connection, a wireless connection, or a combination thereof. The wireless link 606 can include a downlink of data or control information communicated from the base station 604 to the wireless communication device 602 and an uplink of other data or control information communicated from the wireless communication device 602 to the base station 604. The wireless link 606 may be implemented using any suitable communication protocol or standard, such as 3rd Generation Partnership Project Long-Term Evolution (3GPP LTE), 3GPP New Radio Fifth Generation (NR 5G), IEEE 802.11 (WiFi), IEEE 802.16 (WiMAX), Bluetooth™, and so forth.

The wireless communication device 602 includes a processor 608 and a memory 610. The memory 610 may be or form a portion of a computer-readable storage medium. The processor 608 may include any type of processor, such as an application processor or a multi-core processor, that is configured to execute processor-executable instructions (e.g., code) stored by the memory 610. The memory 610 is configured to store instructions (e.g., computer-executable code) that when executed by the processor 608, cause the processor 608 to perform the operations 300 and/or the operations 500 described with respect to FIG. 3 and FIG. 5, or any aspect related to such operations. The memory 610 may include any suitable type of data storage media, such as volatile memory (e.g., random access memory (RAM)), non-volatile memory (e.g., flash memory), optical media, magnetic media (e.g., disk or tape), and so forth. In the context of this disclosure, the memory 610 is implemented to store instructions 612, data 614, and other information of the wireless communication device 602, and thus when configured as or part of a computer-readable storage medium, the memory 610 does not include transitory propagating signals or carrier waves. That is, the memory 610 may include non-transitory computer-readable media (e.g., tangible media).

The wireless communication device 602 may also include input/output ports 616. The I/O ports 616 enable data exchanges or interaction with other devices, networks, or users or between components of the device.

The wireless communication device 602 may further include a signal processor (SP) 618 (e.g., such as a digital signal processor (DSP)). The signal processor 618 may function similar to the processor 608 and may be capable of executing instructions and/or processing information in conjunction with the memory 610.

For communication purposes, the wireless communication device 602 also includes a modem 620, a wireless transceiver 622, and an antenna (not shown). The wireless transceiver 622 provides connectivity to respective networks and other wireless communication devices connected therewith using radio-frequency (RF) wireless signals and may include the RF transceiver (circuit) 100, 200 of FIG. 1 and/or FIG. 2. The wireless transceiver 622 may facilitate communication over any suitable type of wireless network, such as a wireless local area network (WLAN), a peer-to-peer (P2P) network, a mesh network, a cellular network, a wireless wide area network (WWAN), a navigational network (e.g., the global positioning system (GPS) of North America or another global navigation satellite system (GNSS)), and/or a wireless personal area network (WPAN).

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, means for outputting and/or applying a gain may include a transceiver (e.g., the RF transceiver 200) and/or a processor (e.g., the processor 252). Means for determining may include a controller or a processor (e.g., the processor 252).

Based on the present disclosure, it should be appreciated that the transceiver and the method for transmit spur mitigation described herein provide various advantages. The methods and apparatus described herein may allow for online spur detection and mitigation. The methods and apparatus described herein may alleviate EVM degradation with a specific look-up table configured for spurious emission mitigation.

### Example Aspects

In addition to the various aspects described above, specific combinations of aspects are within the scope of the disclosure, some of which are detailed below:

Aspect 1: A method of signal transmission, comprising: outputting a first signal from a transmit chain in a first state; determining that a power associated with the first signal violates a spectral mask; and outputting a second signal from the transmit chain in a second state in response to the determination, the second state being different from the first state.

Aspect 2: The method of Aspect 1, further comprising: outputting a third signal from the transmit chain in the first state; determining that a power associated with the third signal satisfies the spectral mask; and outputting a fourth signal from the transmit chain in the first state in response to the determination of the power associated with the third signal satisfying the spectral mask.

Aspect 3: The method of Aspect 1 or 2, further comprising: obtaining one or more measurements associated with the first signal while outputting the first signal from the transmit chain in the first state, wherein determining that the power associated with the first signal violates the spectral mask comprises determining that the power associated with the first signal violates the spectral mask based at least in part on the one or more measurements associated with the first signal.

Aspect 4: The method of Aspect 3, wherein the one or more measurements are in terms of a transmit power control metric or a decibel relative to a peak spectral power of the first signal.

Aspect 5: The method of Aspect 3 or 4, wherein obtaining the one or more measurements associated with the first signal comprises obtaining the one or more measurements associated with the first signal via a feedback path coupling an output of the transmit chain to a receive chain.

Aspect 6: The method according to any of Aspects 1-5, wherein outputting the second signal from the transmit chain in the second state comprises outputting the second signal from the transmit chain in the second state based at least in part on information associated with the second state.

Aspect 7: The method of Aspect 6, wherein: the information associated with the second state comprises sets of one or more gains associated with the transmit chain; and each of the sets of one or more gains is associated with an output power of the transmit chain.

Aspect 8: The method of Aspect 6 or 7, wherein: the information associated with the second state comprises a first set of one or more gains associated with the transmit chain and a second set of one or more gains associated with the transmit chain; the first set of one or more gains corresponds to a first output power of the transmit chain; and the second set of one or more gains corresponds to a second output power of the transmit chain.

Aspect 9: The method of Aspect 7 or 8, wherein: each of the sets of one or more gains comprises a plurality of gains, and each of the plurality of gains is associated with a different component in the transmit chain; and outputting the second signal from the transmit chain in the second state comprises applying, to a respective component in the transmit chain, each of the plurality of gains in one of the sets of one or more gains corresponding to the second state.

Aspect 10: The method according to any of Aspects 6-9, wherein the information associated with the second state comprises a look-up table of gains associated with different components in the transmit chain.

Aspect 11: The method according to any of Aspects 6-10, wherein the information associated with the second state comprises sets of one or more gains associated with the transmit chain, and each of the sets of one or more gains corresponds to a frequency channel.

Aspect 12: The method according to any of Aspects 6-10, wherein the information associated with the second state comprises sets of one or more gains associated with the transmit chain across multiple frequency channels.

Aspect 13: The method according to any of Aspects 1-12, wherein the spectral mask is specified for wireless communications in a shared spectrum or a wireless local area network.

Aspect 14: The method according to any of Aspects 1-13, wherein the spectral mask includes one or more maximum transmit powers across a frequency spectrum.

Aspect 15: The method according to any of Aspects 1-14, further comprising: obtaining one or more measurements associated with the first signal while outputting the first signal from the transmit chain in a plurality of states or across a plurality of channels, wherein determining that the power associated with the first signal violates the spectral mask comprises determining, for each of the plurality of states or each of the plurality of channels, whether the power associated with the first signal violates the spectral mask.

Aspect 16: The method according to any of Aspects 1-15, further comprising outputting a third signal from the transmit chain in the first state; determining that a power associated with the third signal violates the spectral mask; and outputting a fourth signal from the transmit chain in the second state in response to the determination that the power associated with the third signal violates the spectral mask.

Aspect 17: The method of Aspect 16, wherein determining that the power associated with the third signal violates the spectral mask comprises determining that the power associated with the third signal violates the spectral mask in response to one or more criteria being satisfied.

Aspect 18: The method of Aspect 17, wherein the one or more criteria are satisfied when a timer expires or when an event is detected.

Aspect 19: An apparatus for signal transmission, comprising: a memory; and a processor coupled to the memory, the processor being configured to: cause a transceiver to output a first signal from a transmit chain in a first state, determine that a power associated with the first signal violates a spectral mask, and cause the transceiver to output a second signal from the transmit chain in a second state in response to the determination, the second state being different from the first state.

Aspect 20: The apparatus of Aspect 19, wherein: the processor is further configured to obtain one or more measurements associated with the first signal while outputting the first signal from the transmit chain in the first state; and to determine that the power associated with the first signal violates the spectral mask, the processor is further configured determine that the power associated with the first signal violates the spectral mask based at least in part on the one or more measurements associated with the first signal.

Aspect 21: The apparatus of Aspect 20, further comprising: a feedback path coupled between an output of the transmit chain to a receive chain; and wherein to obtain the one or more measurements associated with the first signal, the processor is further configured to obtain the one or more measurements associated with the first signal via the feedback path coupling the output of the transmit chain to the receive chain.

Aspect 22: The apparatus according to any of Aspects 19-21, wherein to output the second signal from the transmit chain in the second state, the processor is further configured to cause the transceiver to output the second signal from the transmit chain in the second state based at least in part on information associated with the second state.

Aspect 23: The apparatus of Aspect 22, wherein: the information associated with the second state comprises sets of one or more gains associated with the transmit chain; and each of the sets of one or more gains is associated with an output power of the transmit chain.

Aspect 24: The apparatus of Aspect 22 or 23, wherein: the information associated with the second state comprises a first set of one or more gains associated with the transmit chain and a second set of one or more gains associated with the transmit chain; the first set of one or more gains corresponds to a first output power of the transmit chain; and the second set of one or more gains corresponds to a second output power of the transmit chain.

Aspect 25: The apparatus of Aspect 23, wherein: each of the sets of one or more gains comprises a plurality of gains, and each of the plurality of gains is associated with a different component in the transmit chain; and to output the second signal from the transmit chain in the second state, the processor is further configured to cause the transceiver to apply, to a respective component in the transmit chain, each of the plurality of gains in one of the sets of one or more gains corresponding to the second state.

Aspect 26: The apparatus according to any of Aspects 22-25, wherein the information associated with the second state comprises a look-up table of gains associated with different components in the transmit chain.

Aspect 27: The apparatus according to any of Aspects 19-26, wherein the spectral mask is specified for wireless communications in a shared spectrum or a wireless local area network.

Aspect 28: The apparatus according to any of Aspects 19-27, wherein the spectral mask includes one or more maximum transmit powers across a frequency spectrum.

Aspect 29: The apparatus according to any of Aspects 19-28, wherein: the processor is further configured to obtain one or more measurements associated with the first signal while outputting the first signal from the transmit chain in a plurality of states or across a plurality of channels; and to determine that the power associated with the first signal violates the spectral mask, the processor is further configured to determine, for each of the plurality of states or each of the plurality of channels, whether the power associated with the first signal violates the spectral mask.

Aspect 30: The apparatus according to any of Aspects 19-29, wherein the processor is further configured to: cause the transceiver to output a third signal from the transmit chain in the first state; determine that a power associated with the third signal violates the spectral mask; and cause the transceiver to output a fourth signal from the transmit chain in the second state in response to the determination that the power associated with the third signal violates the spectral mask.

Aspect 31: An apparatus, comprising: a memory comprising computer-executable instructions; one or more processors configured to execute the computer-executable instructions and cause the processing system to perform a method in accordance with any of Aspects 1-18.

Aspect 32: An apparatus, comprising means for performing a method in accordance with any of Aspects 1-18.

Aspect 33: A non-transitory computer-readable medium comprising computer-executable instructions that, when executed by one or more processors of a processing system, cause the processing system to perform a method in accordance with any of Aspects 1-18.

Aspect 34: A computer program product embodied on a computer-readable storage medium comprising code for performing a method in accordance with any of Aspects 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a signal may refer to a detectable physical quantity or impulse (such as a voltage, current, or magnetic field strength over time) by which messages or information can be transmitted. A signal may carry information available for observation.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of signal transmission, comprising:
outputting a first signal from a transmit chain in a first state;
determining that a power associated with the first signal violates a spectral mask; and
outputting a second signal from the transmit chain in a second state in response to the determination, the second state being different from the first state.

2. The method of claim 1, further comprising:
outputting a third signal from the transmit chain in the first state;
determining that a power associated with the third signal satisfies the spectral mask; and
outputting a fourth signal from the transmit chain in the first state in response to the determination of the power associated with the third signal satisfying the spectral mask.

3. The method of claim 1, further comprising:
obtaining one or more measurements associated with the first signal while outputting the first signal from the transmit chain in the first state, wherein determining that the power associated with the first signal violates the spectral mask comprises determining that the power associated with the first signal violates the spectral mask based at least in part on the one or more measurements associated with the first signal.

4. The method of claim 3, wherein the one or more measurements are in terms of a transmit power control metric or a decibel relative to a peak spectral power of the first signal.

5. The method of claim 3, wherein obtaining the one or more measurements associated with the first signal comprises obtaining the one or more measurements associated with the first signal via a feedback path coupling an output of the transmit chain to a receive chain.

6. The method of claim 1, wherein outputting the second signal from the transmit chain in the second state comprises outputting the second signal from the transmit chain in the second state based at least in part on information associated with the second state.

7. The method of claim 6, wherein:
the information associated with the second state comprises sets of one or more gains associated with the transmit chain; and
each of the sets of one or more gains is associated with an output power of the transmit chain.

8. The method of claim 6, wherein:
the information associated with the second state comprises a first set of one or more gains associated with the transmit chain and a second set of one or more gains associated with the transmit chain;
the first set of one or more gains corresponds to a first output power of the transmit chain; and
the second set of one or more gains corresponds to a second output power of the transmit chain.

9. The method of claim 7, wherein:
each of the sets of one or more gains comprises a plurality of gains, and each of the plurality of gains is associated with a different component in the transmit chain; and
outputting the second signal from the transmit chain in the second state comprises applying, to a respective component in the transmit chain, each of the plurality of gains in one of the sets of one or more gains corresponding to the second state.

10. The method of claim 6, wherein the information associated with the second state comprises a look-up table of gains associated with different components in the transmit chain.

11. The method of claim 6, wherein the information associated with the second state comprises sets of one or more gains associated with the transmit chain, and each of the sets of one or more gains corresponds to a frequency channel.

12. The method of claim 6, wherein the information associated with the second state comprises sets of one or more gains associated with the transmit chain across multiple frequency channels.

13. The method of claim 1, wherein the spectral mask is specified for wireless communications in a shared spectrum or a wireless local area network.

14. The method of claim 1, wherein the spectral mask includes one or more maximum transmit powers across a frequency spectrum.

15. The method of claim 1, further comprising:
obtaining one or more measurements associated with the first signal while outputting the first signal from the transmit chain in a plurality of states or across a plurality of channels, wherein determining that the power associated with the first signal violates the spectral mask comprises determining, for each of the plurality of states or each of the plurality of channels, whether the power associated with the first signal violates the spectral mask.

16. The method of claim 1, further comprising
outputting a third signal from the transmit chain in the first state;
determining that a power associated with the third signal violates the spectral mask; and
outputting a fourth signal from the transmit chain in the second state in response to the determination that the power associated with the third signal violates the spectral mask.

17. The method of claim 16, wherein determining that the power associated with the third signal violates the spectral mask comprises determining that the power associated with the third signal violates the spectral mask in response to one or more criteria being satisfied.

18. The method of claim 17, wherein the one or more criteria are satisfied when a timer expires or when an event is detected.

19. An apparatus for signal transmission, comprising:
a memory; and
a processor coupled to the memory, the processor being configured to:
cause a transceiver to output a first signal from a transmit chain in a first state,
determine that a power associated with the first signal violates a spectral mask, and
cause the transceiver to output a second signal from the transmit chain in a second state in response to the determination, the second state being different from the first state.

20. The apparatus of claim 19, wherein:
the processor is further configured to obtain one or more measurements associated with the first signal while outputting the first signal from the transmit chain in the first state; and
to determine that the power associated with the first signal violates the spectral mask, the processor is further configured determine that the power associated with the first signal violates the spectral mask based at least in part on the one or more measurements associated with the first signal.

21. The apparatus of claim 20, further comprising:
a feedback path coupled between an output of the transmit chain to a receive chain; and
wherein to obtain the one or more measurements associated with the first signal, the processor is further configured to obtain the one or more measurements associated with the first signal via the feedback path coupling the output of the transmit chain to the receive chain.

22. The apparatus of claim 19, wherein to output the second signal from the transmit chain in the second state, the processor is further configured to cause the transceiver to output the second signal from the transmit chain in the second state based at least in part on information associated with the second state.

23. The apparatus of claim 22, wherein:
the information associated with the second state comprises sets of one or more gains associated with the transmit chain; and
each of the sets of one or more gains is associated with an output power of the transmit chain.

24. The apparatus of claim 22, wherein:
the information associated with the second state comprises a first set of one or more gains associated with the transmit chain and a second set of one or more gains associated with the transmit chain;
the first set of one or more gains corresponds to a first output power of the transmit chain; and
the second set of one or more gains corresponds to a second output power of the transmit chain.

25. The apparatus of claim 23, wherein:
each of the sets of one or more gains comprises a plurality of gains, and each of the plurality of gains is associated with a different component in the transmit chain; and
to output the second signal from the transmit chain in the second state, the processor is further configured to cause the transceiver to apply, to a respective component in the transmit chain, each of the plurality of gains in one of the sets of one or more gains corresponding to the second state.

26. The apparatus of claim 22, wherein the information associated with the second state comprises a look-up table of gains associated with different components in the transmit chain.

27. The apparatus of claim 19, wherein the spectral mask is specified for wireless communications in a shared spectrum or a wireless local area network.

28. The apparatus of claim 19, wherein the spectral mask includes one or more maximum transmit powers across a frequency spectrum.

29. The apparatus of claim 19, wherein:
the processor is further configured to obtain one or more measurements associated with the first signal while outputting the first signal from the transmit chain in a plurality of states or across a plurality of channels; and
to determine that the power associated with the first signal violates the spectral mask, the processor is further configured to determine, for each of the plurality of states or each of the plurality of channels, whether the power associated with the first signal violates the spectral mask.

30. The apparatus of claim 19, wherein the processor is further configured to:
cause the transceiver to output a third signal from the transmit chain in the first state;
determine that a power associated with the third signal violates the spectral mask; and
cause the transceiver to output a fourth signal from the transmit chain in the second state in response to the determination that the power associated with the third signal violates the spectral mask.
